(19) United States
(12) Patent Application Publication
(10) Pub. No.: US 2024/0330839 A1
(43) Pub. Date: Oct. 3, 2024

(54) TRADE LOGISTICS DELIVERY ARRANGEMENT SYSTEM, TRADE LOGISTICS DELIVERY ARRANGEMENT METHOD, AND PROGRAM THEREOF

(71) Applicant: LOGISTEED, LTD., Tokyo (JP)

(72) Inventor: Yasushi SHIMOKOBE, Tokyo (JP)

(21) Appl. No.: 18/693,374

(22) PCT Filed: Jul. 20, 2021
(86) PCT No.: PCT/JP2021/027067

§ 371 Date: Mar. 19, 2024

(51) Int. Cl. G06Q 10/0831; G06Q 10/0834; G06Q 10/0875

(52) U.S. Cl. CPC G06Q 10/0831; G06Q 10/08345; G06Q 10/0875; G06Q 2220/00

(57) ABSTRACT

The trade logistics delivery arrangement system refers a distributed ledger and arranges delivery of an item in trade logistics to satisfy a condition by a combination of land transportation, sea transportation. The air transportation acquires item information on an item stored by a customer, records the acquired item information into a distributed ledger. refers to the item information recorded in the distributed ledger, and calculates a combination of trade logistics vendors that satisfy a condition by a combination of land transportation, sea transportation, and air transportation for trade logistics of the item if the inventory quantity of the item satisfies a predetermined condition, and arranges delivery of the item to a customer with a trade logistics vendor who satisfies a condition based on the calculated combination.

### CROSS-REFERENCE TO RELATED APPLICATION

This application is a national stage of International Application No. PCT/JP2021/027067, filed on Jul. 20, 2021, which is hereby incorporated by reference in its entirety.

### TECHNICAL FIELD

The present disclosure relates to a technology that saves the effort for the inventory management and the trade logistics arrangement of items at a time.

### BACKGROUND

In recent years, technologies that reduce the burden of logistics have been gaining attention. For example, Patent Document 1 (JP2006-85315 A) discloses a technology that allows both exporters and importers of items to accurately understand the current status and the latest transit points of shipped items and that enables importers to properly manage their inventory by incorporating the information into their own inventory information to reduce the effort made by each company involved in trade transactions.

Furthermore, Patent Document 2 (JP2017-199282 A) discloses a technology for selecting an arrangement method by simulating the inventory quantity of items according to the order quantity of items that was calculated based on setting information on parameters related to the arrangement of those items and by calculating the total charge related to inventory management of the items.

### SUMMARY

When the inventory of items runs low, but the relevant items are located overseas, it is necessary to procure them through trade logistics. However, in trade logistics which involves crossing multiple countries and numerous logistics vendors, it is difficult to arrange delivery under a condition, such as at the lowest cost. Therefore, there is a demand for technology that can save the effort for inventory management and the most inexpensive trade logistics arrangement of items at a time.

However, the technologies in Patent Documents 1 and 2 cannot save the effort for inventory management and logistics arrangement of items that satisfy a condition at a time.

An objective of the present disclosure is to provide a trade logistics delivery arrangement system, trade logistics delivery arrangement method, and program thereof that save the effort for inventory management and logistics arrangement of items that satisfy a desired condition at a time by utilizing a distributed ledger.

A first aspect of the present disclosure provides a trade logistics delivery arrangement system that arranges delivery of an item in trade logistics to satisfy a condition by a combination of land transportation, sea transportation, and air transportation, including:
an acquisition unit that acquires item information on an item stored by a customer;
a record unit that records the acquired item information into a ledger;
a calculation unit that refers to the item information recorded in the ledger and calculates a combination of trade logistics vendors that satisfies a condition by a combination of land transportation, sea transportation, and air transportation for trade logistics of the item when the inventory quantity of the item satisfies a predetermined condition; and
an arrangement unit that arranges delivery of the item to a customer with the calculated combination of trade logistics vendors that satisfies a condition.

According to the first aspect of the present disclosure, the trade logistics delivery arrangement system that arranges delivery of an item in trade logistics to satisfy a condition by a combination of land transportation, sea transportation, and air transportation, includes: an acquisition unit that acquires item information on an item stored by a customer; a record unit that records the acquired item information into a ledger; a calculation unit that refers to the item information recorded in the ledger and calculates a combination of trade logistics vendors that satisfies a condition by a combination of land transportation, sea transportation, and air transportation for trade logistics of the item when the inventory quantity of the item satisfies a predetermined condition; and an arrangement unit that arranges delivery of the item to a customer with the calculated combination of trade logistics vendors that satisfies a condition.

While the first aspect of the present disclosure pertains to the category of a trade logistics delivery arrangement system, it is understood that the same functions and effects are applicable to a method and a program as well.

The present disclosure can provide a trade logistics delivery arrangement system, trade logistics delivery arrangement method, and program thereof that save the effort for inventory management and logistics arrangement of items that satisfy a condition at a time by utilizing a distributed ledger.

### BRIEF DESCRIPTION OF THE DRAWINGS

FIG. 1 is a diagram explaining the overview of the trade logistics delivery arrangement system 1.

FIG. 2 is a diagram showing the functional configuration of the trade logistics delivery arrangement system 1.

FIG. 3 is a diagram showing the trade logistics delivery arrangement process executed by the trade logistics delivery arrangement system 1.

FIG. 4 is a diagram showing the delivery charge judgement process executed by the trade logistics delivery arrangement system 1.

FIG. 5 is a diagram showing the environmental load judgement process executed by the trade logistics delivery arrangement system 1.

FIG. 6 is a diagram showing the functional configuration of the trade logistics delivery arrangement system 1 that executes the delivery date judgement process.

FIG. 7 is a diagram showing the delivery date judgement process executed by the trade logistics delivery arrangement system 1.

FIG. 8 is a diagram showing the remaining load capacity judgement process executed by the trade logistics delivery arrangement system 1.

FIG. 9 is a diagram explaining an example data stored in the distributed ledger 200.

### DESCRIPTION OF REFERENCE NUMERALS

1: trade logistics delivery arrangement system, 3: network, 10: item, 50: customer terminal, 51: terminal control unit, 52: input/output unit, 53: communication unit, 100: trade logistics delivery arrangement device, 101: acquisition module, 102: record module, 103: calculation module, 104: arrangement module, 105: delivery date judgement module, 200: distributed ledger, 300: customer, 400: trade logistics vendor

### DETAILED DESCRIPTION OF THE EMBODIMENTS

An embodiment for carrying out the present disclosure (hereinafter referred to as ‘Embodiment’) is explained in detail below with reference to the attached drawings. In the drawings, the same elements throughout the description of Embodiment are designated by the same reference numerals.

### Basic Concept/Basic Configuration

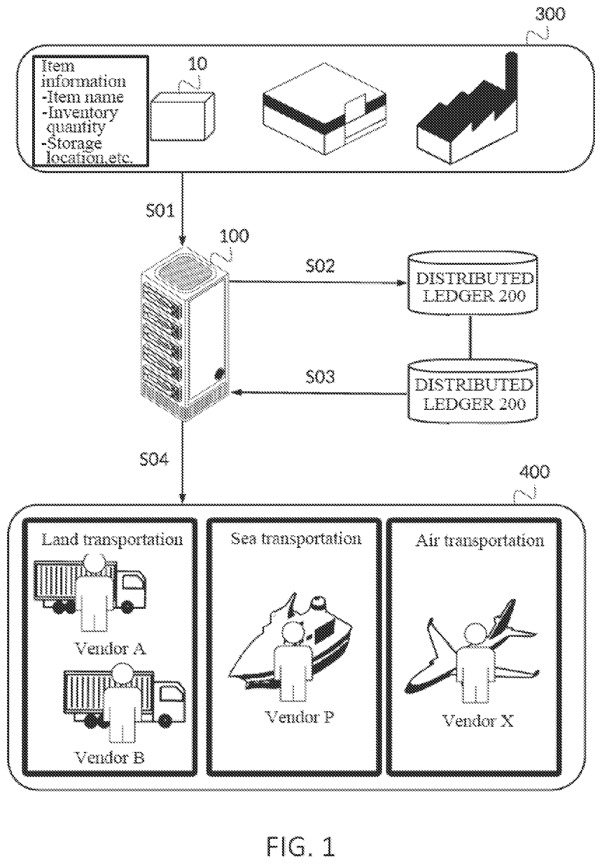

FIG. 1 is a diagram explaining the overview of the trade logistics delivery arrangement system 1. The trade logistics delivery arrangement system 1 is a system that includes at least a trade logistics delivery arrangement device 100 that refers to the ledger 200 and arranges delivery to satisfy a condition, for example, to minimize the combination of delivery charges of trade logistics vendors 400 for trade logistics of an item 10 of a customer 300 and a customer terminal 50 used by the customer 300.

The ledger may be a system equipped with an existing database. The ledger may be a distributed ledger 200 such as a blockchain or IOTA ledger. The reason for using a distributed ledger 200 in the configuration of the trade logistics delivery arrangement system 1 is because distributed ledgers have excellent transparency, security, and tamper resistance. Furthermore, the ledgers can be recorded by users without the need for a third-party body, which also leads to savings of time, effort, and cost. The recorded information is always accessible to users, thus ensuring high transparency. The recorded information is also less susceptible to attacks, thus enhancing security and tamper resistance because ledgers (nodes) are distributed worldwide.

The customer 300 is a store or factory, who wishes to appropriately manage the inventory quantity of an item 10 and to procure the item 10 as inexpensively as possible through trade logistics in the event of its shortage. The customer 300 is a user of the trade logistics delivery arrangement system 1.

The trade logistics vendor 400 is a transporter in each country by land, sea, or air transportation, which deliver an item 10 through trade logistics.

The overview of the trade logistics delivery arrangement system 1 is described below by using an example of satisfying a condition “the most inexpensive delivery charge” by a combination of land transportation, sea transportation, and air transportation. The trade logistics delivery arrangement device 100 appropriately manages the inventory quantity of an item 10 of the customer 300 who uses the trade logistics delivery arrangement system 1 and arranges delivery to minimize the combination of delivery charges of the trade logistics vendors 400 for trade logistics of the item 10.

The trade logistics delivery arrangement device 100 acquires item information on an item 10 stored by a customer 300 (Step S01). The item information herein refers to information necessary for arranging the delivery of an item 10, including the item name, inventory quantity, storage location, size, and weight. The timing for acquiring item information may be on a regular basis, for example, ‘at 1 o'clock every day’, ‘at 2 o'clock on Monday’, ‘every 3 days’, or ‘on the fourth of every month’ or may be at the time when the item information is updated. The timing for acquiring item information can be set according to the needs of a customer 300.

The trade logistics delivery arrangement device 100 records the acquired item information on an item 10 in a distributed ledger 200 (Step S02).

The trade logistics delivery arrangement device 100 refers to the item information recorded in the distributed ledger 200 at Step S02 and calculates a combination of trade logistics vendors 400 that offers the most inexpensive combination of delivery charges of land transportation, sea transportation, and air transportation for trade logistics of the item 10 if the inventory quantity of the item 10 satisfies a predetermined condition (Step S03). The case where the inventory quantity of the item 10 satisfies a predetermined condition is, for example, when the inventory quantity of the item 10 falls below a predetermined threshold. When the inventory quantity of the item 10 falls below a predetermined threshold, the items 10 to be delivered should be arranged so that a certain quantity of the items 10 will be in inventory. For example, if the threshold for an item 10 is set at 50 units and the certain number is set at 100 units and if the quantity of the items 10 falls to 43 units by the use of large quantities of the items 10, then 57 units are arranged as the necessary quantity to reach the certain number of 100 units. In order to arrange the trade logistics of the item 10, the item information is used to extract data such as the name of the item 10, the required quantity, and the storage location as the delivery destination. Based on the extracted data, it is determined which supplier in which country can provide the item 10, which trade logistics vendors 400 can perform land transportation, sea transportation, and air transportation for trade logistics of the item 10 from the supplier, how much delivery charge for each of the trade logistics vendors 400 is, etc., by a search. Then, the combination of trade logistics vendors 400 that offers the most inexpensive combination of delivery charge is calculated. The source for this search may be the Internet. Alternatively, the trade logistics delivery arrangement system 1 may have a database of information on suppliers of the item 10, trade logistics vendors 400, and delivery charges for the trade logistics vendors 400, and this database may be used as the search source.

The trade logistics delivery arrangement device 100 arranges the delivery with the trade logistics vendors 400 that offer the most inexpensive calculated combination of delivery charges, to deliver the required quantity of items 10 to the customer 300 (Step S04). If there are multiple trade logistics vendors 400, arrangements are made with each of them to ensure ‘when and where each of them will receive the item 10 (item name, quantity) from whom, when each of them will deliver and hand over it to which and to whom’. In FIG. 1, since the combination of the land transportation vendors A and B, the sea transportation vendor P, and the air transportation vendor X is the most inexpensive, the delivery is arranged with these trade logistics vendors 400.

According to the trade logistics delivery arrangement 1, the customer 300 can save the effort for inventory management and trade logistics arrangement of an item 10 at a time.

### Functional Configuration

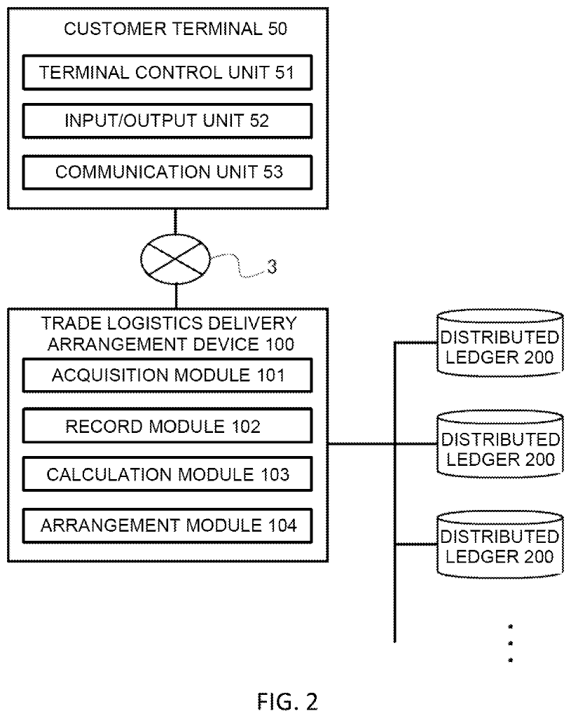

The functional configuration of the trade logistics delivery arrangement system 1 is described below with reference to FIG. 2 The trade logistics delivery arrangement system 1 includes a trade logistics delivery arrangement device 100, a customer terminal 50 that communicatively connected with this trade logistics delivery arrangement device 100 via a network 3, and a distributed ledger 200. The trade logistics delivery arrangement device 100 is not limited to a physical device, which may be a virtual device. The trade logistics delivery arrangement system 1 may include other terminals, devices, etc. In this case, the trade logistics delivery arrangement system 1 performs the processes described later through a combination of the trade logistics delivery arrangement device 100, the customer terminal 50, the distributed ledger 200, and/or any other terminals or devices.

The trade logistics delivery arrangement device 100 is a computer, a personal computer, etc., with server functions managed by a company, etc., who operates the trade logistics delivery arrangement system 1, which is data-communicatively connected with the above-mentioned customer terminal 50, distributed ledger 200, and other terminals, devices, etc., via a network 3 such as a public line network. The trade logistics delivery arrangement device 100 performs the transmission and reception of necessary data and various processing tasks.

The trade logistics delivery arrangement device 100 may be realized on a single computer or may be implemented across multiple computers like a cloud computer. The ‘cloud computer’ herein refers to the scalable use of any computer to perform a certain specific function, or to a system that includes multiple functional modules which can be freely combined and used to realize a system.

The trade logistics delivery arrangement device 100 has a control unit (not shown) equipped with a CPU (Central Processing Unit), GPU (Graphics Processing Unit), RAM (Random Access Memory), ROM (Read Only Memory), etc., and a communication unit (not shown) equipped with devices that are communicative with other terminals and devices, for example, Wi-Fi (Wireless-Fidelity) compatible devices that comply with the IEEE 802.11 standard. The trade logistics delivery arrangement device 100 also has a storage unit equipped with data storage such as hard disks, semiconductor memory, storage media, memory cards, etc. The trade logistics delivery arrangement device 100 also has a processing unit (not shown) equipped with various devices, etc., for executing various processes.

In the trade logistics delivery arrangement device 100, the control unit cooperates with the communication unit, the storage unit, and the processing unit to achieve an acquisition module 101, a record module 102, a calculation module 103, and an arrangement module 104 by reading a predetermined program.

The customer terminal 50 is a personal computer, a mobile device such as a smartphone or tablet, or a wearable terminal such as smart glasses or a head-mounted display, which is owned by the customer 300. The customer terminal 50 is data-communicatively connected to the above-mentioned trade logistics delivery arrangement device 100 via a network 3, which performs the transmission and reception of necessary data and various processing tasks.

The customer terminal 50 has the terminal control unit 51 equipped with a CPU, GPU, RAM, ROM, etc., in the same way as the above-mentioned control unit of the trade logistics delivery arrangement device 100. The customer terminal 50 also has an input/output unit 52 equipped with input/output devices, etc., for input/output data, etc. The customer terminal 50 also has a communication unit 53 equipped with devices, etc., that are communicative with the trade logistics delivery arrangement device 100.

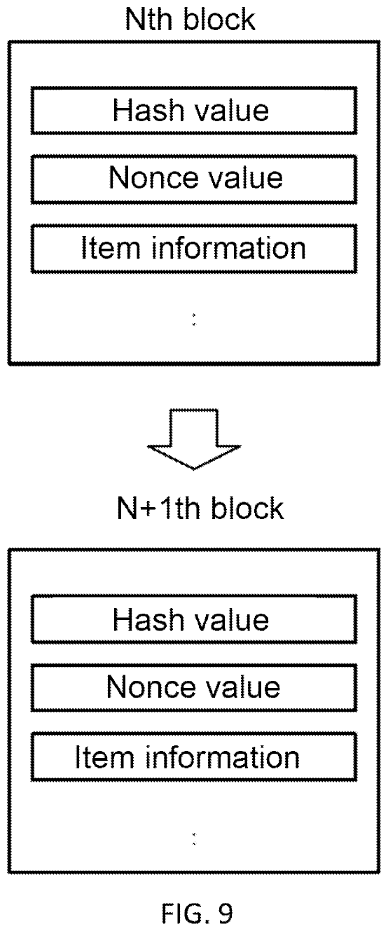

The information that the distributed ledger 200 distributively stores is described below with reference to FIG. 9. FIG. 9 is a conceptual diagram explaining an example data stored in the distributed ledger 200. An example of a distributed ledger includes blockchain technology. In this embodiment, various data related to the item information on an item 10 and logistics delivery (such as delivery charge data, data related to environmental load, date and time data related to the delivery deadline, and data on the load capacity of each cargo carrier) are distributively stored.

In FIG. 9, the nth block represents the last block of the blockchain, and the n+1th represents the block that is being created to be added to the blockchain with the 1st to the nth blocks registered. The nth block contains the hash value of the previous block, a nonce value unique to the block, and item information.

When attempting to add a new block to the blockchain with the 1st to the nth blocks registered, the calculation module 103 performs calculation to find a nonce value that makes the hash value of the block satisfy a specific condition. The record module 102 registers a new block containing the hash value of the previous block, the nonce value, and the item information to the blockchain based on the calculation result.

In this embodiment, a blockchain is used as an example of the distributed ledger, but the distributed ledger in the present disclosure is not limited to a blockchain.

### Trade Logistics Delivery Arrangement Process

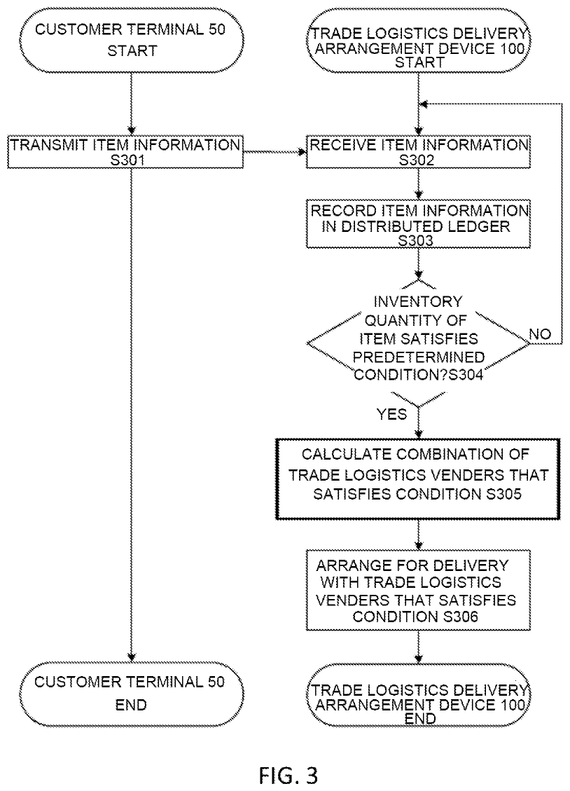

The trade logistics delivery arrangement process performed by the trade logistics delivery arrangement device 100 and the customer terminal 50 is described below with reference to FIG. 3. FIG. 3 is a diagram showing the flow chart of the trade logistics delivery arrangement process executed by the trade logistics delivery arrangement device 100 and the customer terminal 50. The processes executed by the above-mentioned modules are described in conjunction with this process. Although FIG. 2 illustrates that the acquisition module 101, the record module 102, the calculation module 103, and the arrangement module 104 operate on the trade logistics delivery arrangement device 100, these modules may also operate on the customer terminal 50 by the terminal control unit 51 executing certain programs, cooperating with the input/output unit 52 and the communication unit 53.

The customer terminal 50 of a customer 300 transmits the item information on an item 10 to the trade logistics delivery arrangement device 100 (Step S301). The item information herein refers to information necessary for arranging the delivery of an item 10, including the item name, inventory quantity, and storage location. The timing for transmitting item information may be on a regular basis, for example, ‘at 1 o'clock every day’, ‘at 2 o'clock on Monday’, ‘every 3 days’, or ‘on the fourth of every month’ or may be at the time when the item information is updated. The timing for transmitting item information can be set according to the needs of a customer 300.

The acquisition module 101 of the trade logistics delivery arrangement device 100 receives the item information (Step S302). Although FIG. 3 illustrates the flow of transmitting item information from the customer terminal 50, it is also possible to configure the acquisition module 101 of the trade logistics delivery arrangement device 100 to inquire about the item information from the customer terminal 50. In this case, the timing for inquiring item information can be set according to the needs of a customer 300.

The record module 102 of the trade logistics delivery arrangement device 100 records the item information on an item 10 that has been acquired in Step S302 in a distributed ledger 200 (Step S303).

The calculation module 103 of the trade logistics delivery arrangement device 100 refers to the item information recorded in the distributed ledger 200 in Step S303 to check whether or not the inventory quantity of the item 10 satisfies a predetermined condition (Step S304). The case where the inventory quantity of the item 10 satisfies a predetermined condition is, for example, when the inventory quantity of the item 10 falls below a predetermined threshold. When the inventory quantity of the item 10 falls below a predetermined threshold, the items 10 to be delivered should be arranged so that a certain quantity of the items 10 will be in inventory. For example, if the threshold for an item 10 is set at 50 units and the certain number is set at 100 units and if the quantity of the items 10 falls to 43 units by the use of large quantities of the items 10, then 57 units are arranged as the necessary quantity to reach the certain number of 100 units. If the inventory quantity of the item 10 satisfies a specified condition, the process moves to Step S305; if the inventory quantity does not satisfy a predetermined condition, the process returns to before Step S302.

The calculation module 103 refers to the item information recorded in the ledger and calculates a combination of trade logistics vendors 400 that satisfies a condition by a combination of land transportation, sea transportation, and air transportation for trade logistics of the item 10 if the inventory quantity of the item 10 satisfies a predetermined condition (Step S305). In order to arrange the trade logistics of the item 10, the item information is used to extract data such as the name of the item 10, the required quantity, the storage location as the delivery destination, and the cargo load. Based on the extracted data, it is determined which supplier in which country can provide the item 10, which trade logistics vendors 400 can perform land transportation, sea transportation, and air transportation for trade logistics of the item 10 from the supplier, etc. Then, the combination of trade logistics vendors 400 that satisfies a condition is calculated. The source for this search may be the Internet. Alternatively, the trade logistics delivery arrangement system 1 may have a database of information on suppliers of the item 10, trade logistics vendors 400, and delivery charges for the trade logistics vendors 400, and this database may be used as the search source.

The arrangement module 104 of the trade logistics delivery arrangement device 100 arranges the delivery with the trade logistics vendors 400 that satisfy a condition, to deliver the required quantity of items 10 to the customer 300 (Step S306). If there are multiple trade logistics vendors 400, arrangements are made with each of them to ensure ‘when and where each of them will receive the item 10 (item name, quantity) from whom, when each of them will deliver and hand over it to which and to whom. The arrangement module 104 may also generate information of a letter of credit, a bill of lading, a certificate of insurance, a bill of exchange, etc. for delivery of the item 10, The creation and provision of this information to the trade logistics vendors 400 allows for arrangement of reliable delivery.

According to the trade logistics delivery arrangement 1, the customer 300 can save the effort for inventory management and trade logistics arrangement of an item 10 at a time.

The condition includes a delivery charge condition, an environmental load condition, a delivery deadline condition, and a remaining loading capacity condition. The delivery charge condition specifies the upper limit or range or the most inexpensive of the delivery charge. The environmental load condition specifies the upper limit or range or the lowest amount of emission of gases such as carbon dioxide and nitrogen oxide emitted by cargo carriers. The delivery deadline condition specifies the deadline or range for the delivery time of the item or the earliest delivery time. The remaining loading capacity condition specifies the minimum or range or the maximum remaining loading capacity for land transportation, sea transportation, and air transportation.

These conditions are input by the customer into the customer terminal 50 and transmitted to the trade logistics delivery arrangement device 100.

### Delivery Charge Judgement Process

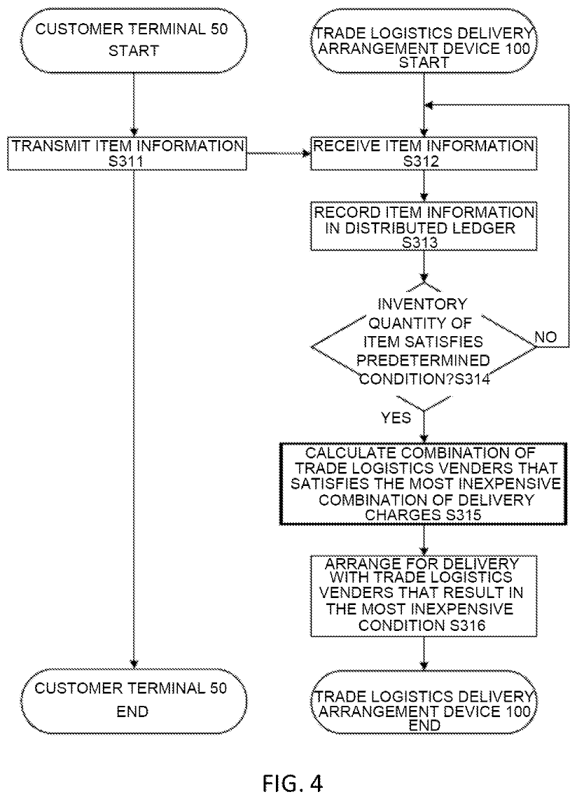

The delivery charge judgement process performed by the trade logistics delivery arrangement device 100 and the customer terminal 50 is described below with reference to FIG. 4. FIG. 4 is a diagram showing the flow chart of the delivery charge judgement process executed by the trade logistics delivery arrangement device 100 and the customer terminal 50. The processes executed by the above-mentioned modules are described in conjunction with this process. Although FIG. 2 illustrates that the acquisition module 101, the record module 102, the calculation module 103, and the arrangement module 104 operate on the trade logistics delivery arrangement device 100, these modules may also operate on the customer terminal 50 by the terminal control unit 51 executing certain programs, cooperating with the input/output unit 52 and the communication unit 53.

The customer terminal 50 of a customer 300 transmits the item information on an item 10 to the trade logistics delivery arrangement device 100 (Step S311). The item information herein refers to information necessary for arranging the delivery of an item 10, including the item name, inventory quantity, and storage location. The timing for transmitting item information may be on a regular basis, for example, ‘at 1 o'clock every day’, ‘at 2 o'clock on Monday’, ‘every 3 days’, or ‘on the fourth of every month’ or may be at the time when the item information is updated. The timing for transmitting item information can be set according to the needs of a customer 300.

The acquisition module 101 of the trade logistics delivery arrangement device 100 receives the item information (Step S312). Although FIG. 4 illustrates the flow of transmitting item information from the customer terminal 50, it is also possible to configure the acquisition module 101 of the trade logistics delivery arrangement device 100 to inquire about the item information from the customer terminal 50. In this case, the timing for inquiring item information can be set according to the needs of a customer 300.

The record module 102 of the trade logistics delivery arrangement device 100 records the item information on an item 10 that has been acquired in Step S312 in a distributed ledger 200 (Step S313).

The calculation module 103 of the trade logistics delivery arrangement device 100 refers to the item information recorded in the distributed ledger 200 in Step S313 to check whether or not the inventory quantity of the item 10 satisfies a predetermined condition (Step S314). The case where the inventory quantity of the item 10 satisfies a predetermined condition is, for example, when the inventory quantity of the item 10 falls below a predetermined threshold. When the inventory quantity of the item 10 falls below a predetermined threshold, the items 10 to be delivered should be arranged so that a certain quantity of the items 10 will be in inventory. For example, if the threshold for an item 10 is set at 50 units and the certain number is set at 100 units and if the quantity of the items 10 falls to 43 units by the use of large quantities of the items 10, then 57 units are arranged as the necessary quantity to reach the certain number of 100 units. If the inventory quantity of the item 10 satisfies a specified condition, the process moves to Step S314; if the inventory quantity does not satisfy a predetermined condition, the process returns to before Step S312.

The calculation module 103 refers to the item information recorded in the ledger and calculates a combination of trade logistics vendors 400 that offers the most inexpensive combination of delivery charges of land transportation, sea transportation, and air transportation for trade logistics of the item 10 if the inventory quantity of the item 10 satisfies a predetermined condition (Step S315). In order to arrange the trade logistics of the item 10, the item information is used to extract data such as the name of the item 10, the required quantity, the storage location as the delivery destination, and the cargo load. Based on the extracted data, it is determined which supplier in which country can provide the item 10, which trade logistics vendors 400 can perform land transportation, sea transportation, and air transportation for trade logistics of the item 10 from the supplier, how much delivery charge for each of the trade logistics vendors 400 is, etc., by a search. Then, the combination of trade logistics vendors 400 that offers the most inexpensive combination of delivery charge is calculated. The source for this search may be the Internet. Alternatively, the trade logistics delivery arrangement system 1 may have a database of information on suppliers of the item 10, trade logistics vendors 400, and delivery charges for the trade logistics vendors 400, and this database may be used as the search source.

The arrangement module 104 of the trade logistics delivery arrangement device 100 arranges the delivery with the trade logistics vendors 400 that offer the most inexpensive calculated combination of delivery charges, to deliver the required quantity of items 10 to the customer 300 (Step S316). If there are multiple trade logistics vendors 400, arrangements are made with each of them to ensure ‘when and where each of them will receive the item 10 (item name, quantity) from whom, when each of them will deliver and hand over it to which and to whom. The arrangement module 104 may also generate information of a letter of credit, a bill of lading, a certificate of insurance, a bill of exchange, etc. for delivery of the item 10. The creation and provision of this information to the trade logistics vendors 400 allows for arrangement of reliable delivery.

According to the trade logistics delivery arrangement 1, the customer 300 can save the effort for inventory management and the most inexpensive trade logistics arrangement of items at a time.

The flowchart in FIG. 4 illustrates the case for calculating the combination of trade logistics vendors 400 that offers the most inexpensive delivery charge combination for items 10. However, it is also possible to calculate the combination of trade logistics vendors 400 that offers the most inexpensive combination of the price and delivery charge of the item 10. When there are multiple operators handling the item 10, the price of the item 10 varies depending on the operator. The distance to the delivery destination and the combination of trade logistics vendors 400 also varies depending on the location of the operator. Furthermore, when the locations of the operators are in different countries, it is necessary to consider the currency exchange due to the difference in currency. By taking all these factors into account and calculating them, the customer 300 can appropriately manage inventory at the lowest cost. For example, if arranging for the item 10 as an article through a supplier in Japan and trading it along the route from Japan to Brazil via the United States is more expensive than arranging it through a supplier in Indonesia and trading it along the route from Indonesia to Brazil via Ecuador, then the route from Indonesia to Brazil via Ecuador should be arranged, considering the charge of item 10 and the currency exchange.

### Environmental Load Judgement Process

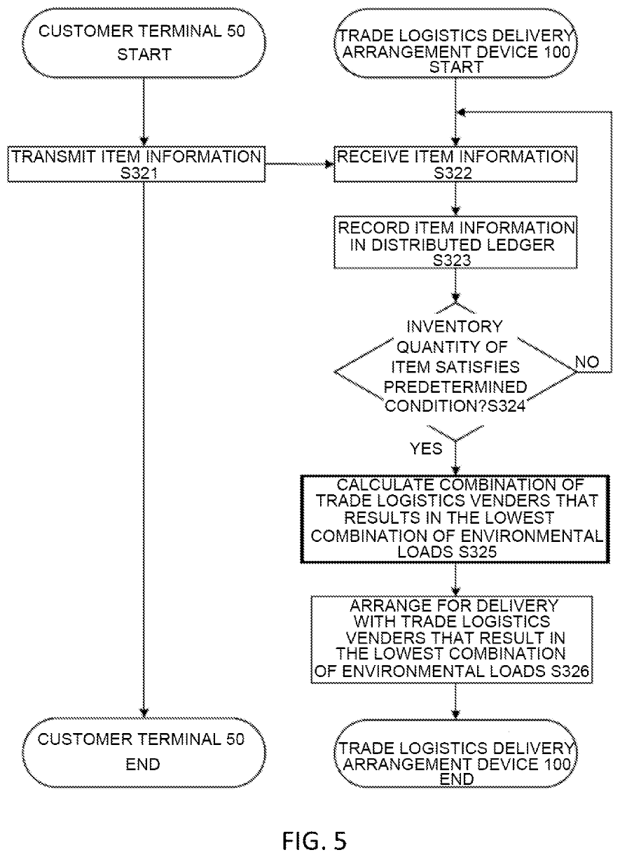

The environmental load judgement process performed by the trade logistics delivery arrangement device 100 and the customer terminal 50 is described below with reference to FIG. 5. FIG. 5 is a diagram showing the flow chart of the environmental load judgement process executed by the trade logistics delivery arrangement device 100 and the customer terminal 50. The processes executed by the above-mentioned modules are described in conjunction with this process. Although FIG. 2 illustrates that the acquisition module 101, the record module 102, the calculation module 103, and the arrangement module 104 operate on the trade logistics delivery arrangement device 100, these modules may also operate on the customer terminal 50 by the terminal control unit 51 executing certain programs, cooperating with the input/output unit 52 and the communication unit 53.

The customer terminal 50 of a customer 300 transmits the item information on an item 10 to the trade logistics delivery arrangement device 100 (Step S321). The item information herein refers to information necessary for arranging the delivery of an item 10, including the item name, inventory quantity, and storage location. The timing for transmitting item information may be on a regular basis, for example, ‘at 1 o'clock every day’, ‘at 2 o'clock on Monday’, ‘every 3 days’, or ‘on the fourth of every month’ or may be at the time when the item information is updated. The timing for transmitting item information can be set according to the needs of a customer 300.

The acquisition module 101 of the trade logistics delivery arrangement device 100 receives the item information (Step S322). Although FIG. 5 illustrates the flow of transmitting item information from the customer terminal 50, it is also possible to configure the acquisition module 101 of the trade logistics delivery arrangement device 100 to inquire about the item information from the customer terminal 50. In this case, the timing for inquiring item information can be set according to the needs of a customer 300.

The record module 102 of the trade logistics delivery arrangement device 100 records the item information on an item 10 that has been acquired in Step S322 in a distributed ledger 200 (Step S323).

The calculation module 103 of the trade logistics delivery arrangement device 100 refers to the item information recorded in the distributed ledger 200 in Step S323 to check whether or not the inventory quantity of the item 10 satisfies a predetermined condition (Step S324). The case where the inventory quantity of the item 10 satisfies a predetermined condition is, for example, when the inventory quantity of the item 10 falls below a predetermined threshold. When the inventory quantity of the item 10 falls below a predetermined threshold, the items 10 to be delivered should be arranged so that a certain quantity of the items 10 will be in inventory. For example, if the threshold for an item 10 is set at 50 units and the certain number is set at 100 units and if the quantity of the items 10 falls to 43 units by the use of large quantities of the items 10, then 57 units are arranged as the necessary quantity to reach the certain number of 100 units. If the inventory quantity of the item 10 satisfies a specified condition, the process moves to Step S325; if the inventory quantity does not satisfy a predetermined condition, the process returns to before Step S322.

The calculation module 103 refers to the item information recorded in the ledger and calculates a combination of trade logistics vendors 400 that results in the lowest combination of environmental loads of land transportation, sea transportation, and air transportation for trade logistics of the item 10 if the inventory quantity of the item 10 satisfies a predetermined condition (Step S325). In order to arrange the trade logistics of the item 10, the item information is used to extract data such as the name of the item 10, the required quantity, the storage location as the delivery destination, and the cargo load. Based on the extracted data, it is determined which supplier in which country can provide the item 10, which trade logistics vendors 400 can perform land transportation, sea transportation, and air transportation for trade logistics of the item 10 from the supplier, how much environmental load for each of the trade logistics vendors 400 is, etc., by a search. Then, the combination of trade logistics vendors 400 that results in the lowest combination of environmental load is calculated. The source for this search may be the Internet. Alternatively, the trade logistics delivery arrangement system 1 may have a database of information on suppliers of the item 10, trade logistics vendors 400, and the environmental load for each trade logistics vendor 400, and this database may be used as the search source.

The arrangement module 104 of the trade logistics delivery arrangement device 100 arranges the delivery with the trade logistics vendors 400 that results in the lowest calculated combination of environmental loads, to deliver the required quantity of items 10 to the customer 300 (Step S326). If there are multiple trade logistics vendors 400, arrangements are made with each of them to ensure ‘when and where each of them will receive the item 10 (item name, quantity) from whom, when each of them will deliver and hand over it to which and to whom. The arrangement module 104 may also generate information of a letter of credit, a bill of lading, a certificate of insurance, a bill of exchange, etc. for delivery of the item 10. The creation and provision of this information to the trade logistics vendors 400 allows for arrangement of reliable delivery.

According to the trade logistics delivery arrangement 1, the customer 300 can save the effort for inventory management and the trade logistics arrangement of an item 10 with the lowest environmental load at a time.

### Functional Configuration for Delivery Date Judgement Process

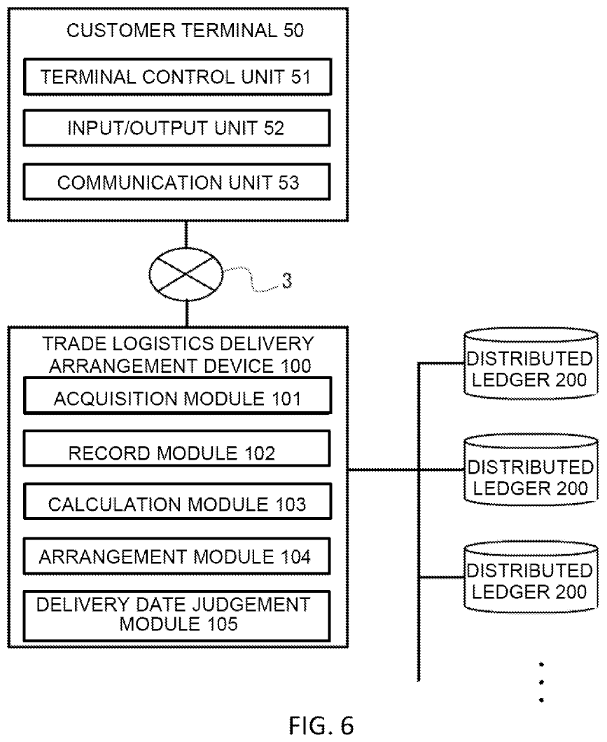

The functional configuration of the trade logistics delivery arrangement system 1 that executes the delivery date judgement process is described below with reference to FIG. 6. FIG. 6 is a diagram showing the functional configuration of the trade logistics delivery arrangement system 1 that executes the delivery date judgement process. In addition to the functional configuration of FIG. 2, in the trade logistics delivery arrangement device 100, the control unit cooperates with the communication unit, the storage unit, and the processing unit to achieve a delivery date judgement module 105 by reading a predetermined program. The processes involved in realizing each module is described in detail below.

### Delivery Date Judgement Process

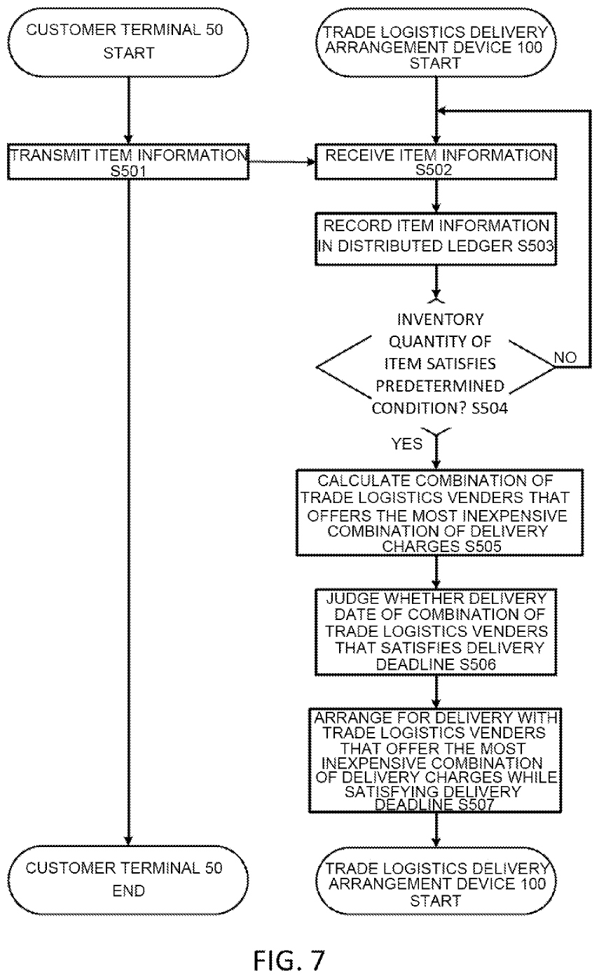

The delivery date judgement process performed by the trade logistics delivery arrangement device 100 and the customer terminal 50 is described below with reference to FIG. 7. FIG. 7 is a diagram showing the delivery date judgement process executed by the trade logistics delivery arrangement system 1. In addition to the functional configuration of FIG. 2, the control unit of the trade logistics delivery arrangement device 100 cooperates with the communication unit, the storage unit, and the processing unit to achieve a delivery date judgement module 105 by reading a predetermined program. The delivery date judgement module 105 may operate on the customer terminal 50 by the terminal control unit 51 executing certain programs, cooperating with the input/output unit 52 and the communication unit 53.

The Steps S501 to S505 in FIG. 7 correspond to the above-mentioned Steps S311 to S315. Thus, the Steps from S506 are described in detail below.

After calculating the combination of trade logistics vendors 400 that results in the most inexpensive combination of the delivery charge of land transportation, sea transportation, and air transportation for trade logistics of the item 10, the delivery date judgement module 105 of the trade logistics delivery arrangement device 100 judges whether or not the delivery date of the combination of land transportation, sea transportation, and air transportation for trade logistics of the item 10 satisfies the delivery deadline (Step S506). The delivery deadline may be included in the item information as a condition that the arrangement within a certain number of days is required or may be specified by the customer 300 through the customer terminal 50 when the item information is transmitted in Step S501. At the point, it only has to be judged whether or not the delivery date satisfies the deadline in ascending order according to combination of delivery charges.

The arrangement module 104 of the trade logistics delivery arrangement device 100 arranges the delivery with the trade logistics vendors 400 that offer the most inexpensive calculated combination of delivery charges while satisfying the delivery deadline, to deliver the required quantity of items 10 to the customer 300 (Step S507). If there are multiple trade logistics vendors 400, arrangements are made with each of them to ensure ‘when and where each of them will receive the item 10 (item name, quantity) from whom, when each of them will deliver and hand over it to which and to whom.

FIG. 7 shows a flowchart for arranging delivery with the trade logistics vendors 400 that offer the most inexpensive combination while satisfying the delivery deadline. However, as an alternative setting, the trade logistics delivery arrangement system 1 may allow for specification of “the combination of trade logistics vendors 400 that offers the earliest delivery date regardless of delivery charges.” In that case, the order of Step S505 and Step S506 can be reversed to first determine the combination of trade logistics vendors 400 that result in the earliest delivery date and then calculate the combination of delivery charges.

According to the trade logistics delivery arrangement system 1, it is possible to arrange the trade logistics vendors 400 that offer the most inexpensive combination while satisfying the delivery deadline, ensuring the necessary quantity of an item 10. Consequently, the customer 300 can save the effort for inventory management and the most inexpensive trade logistics arrangement of an item 10 at a time.

### Remaining Load Capacity Judgement Process

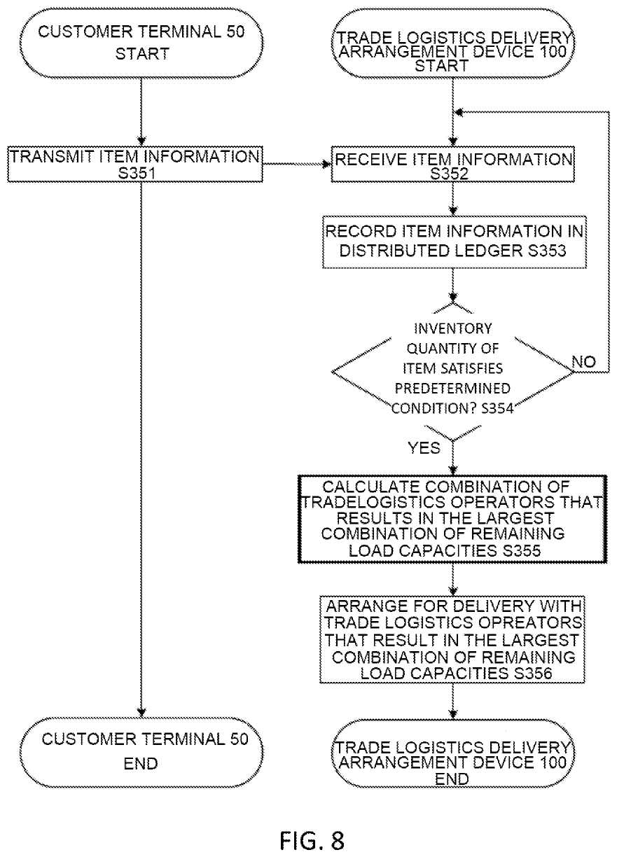

The remaining load capacity judgement process performed by the trade logistics delivery arrangement device 100 and the customer terminal 50 is described below with reference to FIG. 8. FIG. 8 is a diagram showing the flow chart of the remaining load capacity judgement process executed by the trade logistics delivery arrangement device 100 and the customer terminal 50. The processes executed by the above-mentioned modules are described in conjunction with this process.

The customer terminal 50 of a customer 300 transmits the item information on an item 10 to the trade logistics delivery arrangement device 100 (Step S351). The item information herein refers to information necessary for arranging the delivery of an item 10, including the item name, inventory quantity, and storage location. The timing for transmitting item information may be on a regular basis, for example, ‘at 1 o'clock every day’, ‘at 2 o'clock on Monday’, ‘every 3 days’, or ‘on the fourth of every month’ or may be at the time when the item information is updated. The timing for transmitting item information can be set according to the needs of a customer 300.

The acquisition module 101 of the trade logistics delivery arrangement device 100 receives the item information (Step S352). Although FIG. 1 illustrates the flow of transmitting item information from the customer terminal 50, it is also possible to configure the acquisition module 101 of the trade logistics delivery arrangement device 100 to inquire about the item information from the customer terminal 50. In this case, the timing for inquiring item information can be set according to the needs of a customer 300.

The record module 102 of the trade logistics delivery arrangement device 100 records the item information on an item 10 that has been acquired in Step S352 in a distributed ledger 200 (Step S353).

The calculation module 103 of the trade logistics delivery arrangement device 100 refers to the item information recorded in the distributed ledger 200 in Step S353 to check whether or not the inventory quantity of the item 10 satisfies a predetermined condition (Step S354). The case where the inventory quantity of the item 10 satisfies a predetermined condition is, for example, when the inventory quantity of the item 10 falls below a predetermined threshold. When the inventory quantity of the item 10 falls below a predetermined threshold, the items 10 to be delivered should be arranged so that a certain quantity of the items 10 will be in inventory. For example, if the threshold for an item 10 is set at 50 units and the certain number is set at 100 units and if the quantity of the items 10 falls to 43 units by the use of large quantities of the items 10, then 57 units are arranged as the necessary quantity to reach the certain number of 100 units. If the inventory quantity of the item 10 satisfies a specified condition, the process moves to Step S355; if the inventory quantity does not satisfy a predetermined condition, the process returns to before Step S352.

The calculation module 103 refers to the item information recorded in the ledger and calculates a combination of trade logistics vendors 400 that result in the largest combination of remaining load capacities of land transportation, sea transportation, and air transportation for trade logistics of the item 10 if the inventory quantity of the item 10 satisfies a predetermined condition (Step S355). In order to arrange the trade logistics of the item 10, the item information is used to extract data such as the name of the item 10, the required quantity, the storage location as the delivery destination, and the cargo load. Based on the extracted data, it is determined which supplier in which country can provide the item 10, which trade logistics vendors 400 can perform land transportation, sea transportation, and air transportation for trade logistics of the item 10 from the supplier, how much delivery charge for each of the trade logistics vendors 400 is, etc., by a search. Then, the combination of trade logistics vendors 400 that results in the largest combination of remaining load capacities is calculated. The source for this search may be the Internet. Alternatively, the trade logistics delivery arrangement system 1 may have a database of information on suppliers of the item 10, trade logistics vendors 400, and delivery charges for the trade logistics vendors 400, and this database may be used as the search source.

The arrangement module 104 of the trade logistics delivery arrangement device 100 arranges the delivery with the trade logistics vendors 400 that result in the largest calculated combination of the load capacities, to deliver the required quantity of items 10 to the customer 300 (Step S356). If there are multiple trade logistics vendors 400, arrangements are made with each of them to ensure ‘when and where each of them will receive the item 10 (item name, quantity) from whom, when each of them will deliver and hand over it to which and to whom. The arrangement module 104 may also generate information of a letter of credit, a bill of lading, a certificate of insurance, a bill of exchange, etc. for delivery of the item 10. The creation and provision of this information to the trade logistics vendors 400 allows for arrangement of reliable delivery.

According to the trade logistics delivery arrangement 1, the customer 300 can save the effort for inventory management and trade logistics arrangement of an item 10 at a time.

The “remaining load capacity” herein refers to the transportable capacity and weight of cargo carriers used in land transportation, sea transportation, and air transportation. In a single cargo carrier, the remaining load capacity is calculated by subtracting the cargo load from the maximum load capacity. In other words, the remaining load capacity indicates how much cargo can be loaded into the trunk of a cargo carrier, which is specifically represented by the dimensions of length, width, and height, and the maximum load weight that can be carried. For example, if a large truck has a maximum load capacity of 9500 mm, 2400 mm, 2400 mm, and 25000 kg, and this truck has already accepted cargo with a load (hereinafter referred to as ‘cargo load’) of 5000 mm, 1000 mm, 1000 mm, and 14000 kg, the remaining load capacity is displayed as 4500 mm, 1400 mm, 1400 mm, and 11000 kg. Then, it is judged whether or not it is possible to load more cargo in comparison to the cargo load. The same judgement is made for air transportation and sea transportation.

Trade logistics vendors with larger remaining load capacities refer to, for example, the combination of land transportation, sea transportation, and air transportation companies that own cargo carriers with the largest remaining load capacities which are searched from the database if companies of land transportation, sea transportation, and air transportations are needed for the delivery of certain cargo.

The maximum load capacity may be previously registered in the database by transportation vendors, etc. The cargo load may be applied from the customer terminal 50. The remaining load capacity may be determined by subtracting the cargo load applied from the customer terminal 50 from the maximum load capacity registered in the database by the trade logistics delivery system 1. The application for the remaining load capacity may be accepted from the transportation vendor responsible for transporting the cargo. Accordingly, the necessary volume and weight can be reflected in the surplus load capacity if the transportation vendor decides to add cushioning material between cargos. In this case, the application for remaining load capacity from a transportation vendor is made by inputting the surplus load capacity to a transportation vendor terminal, not shown in the drawings, and transmitting it to the trade logistics delivery system 1. If there is no cargo that has been accepted, the surplus load capacity will be equal to the maximum load capacity.

The remaining load capacity, maximum load capacity, and cargo load may be registered in a distributed ledger. Accordingly, the trade logistics delivery system 1 can acquire information from other ledgers and continue to accept cargo orders even if some distributed ledgers cause failure.

(1) A trade logistics delivery arrangement system that arranges delivery of an item in trade logistics to satisfy a condition by a combination of land transportation, sea transportation, and air transportation, including:
an acquisition unit that acquires item information on an item stored by a customer;
a record unit that records the acquired item information into a ledger;
a calculation unit that refers to the item information recorded in the ledger and calculates a combination of trade logistics vendors that satisfies a condition by a combination of land transportation, sea transportation, and air transportation for trade logistics of the item when the inventory quantity of the item satisfies a predetermined condition; and
an arrangement unit that arranges delivery of the item to a customer with the calculated combination of trade logistics vendors that satisfies a condition.

(2) The trade logistics delivery arrangement system according to (1), in which the condition is that the combination of the delivery charges of the land transportation, the sea transportation, and the air transportation is the most inexpensive.

(3) The trade logistics delivery arrangement system according to (1), in which the condition is that the combination of the environmental loads of the land transportation, the sea transportation, and the air transportation is the lowest.

(4) The trade logistics delivery arrangement system according to (1), in which the condition is that the combination of the delivery dates of the land transportation, the sea transportation, and the air transportation is the earliest.

(5) The trade logistics delivery arrangement system according to (1), in which the condition is that the combination of the remaining load capacities of the land transportation, the sea transportation, and the air transportation is the largest.

(6) The trade logistics delivery arrangement system according to any one of (1) to (5), in which the condition includes that the combination of delivery dates of the land transportation, the sea transportation, and the air transportation satisfies a specified period.

(7) The trade logistics delivery arrangement system according to any one of (1) to (6), in which the condition includes that the remaining load capacities of the land transportation, the sea transportation, and the air transportation is within their respective predetermined ranges.

(8) The trade logistics delivery arrangement system according to (2), in which the calculation unit further calculates the combination of trade logistics vendors that results in the most inexpensive combination of the price of the item and the delivery charge of land transportation, sea transportation, and air transportation for trade logistics of the item.

(9) The trade logistics delivery arrangement system according to any one of (1) to (8), in which the arrangement unit generates information of a letter of credit, a bill of lading, a certificate of insurance, or a bill of exchange for delivery of the item.

(10) The trade logistics delivery arrangement system according to any one of (2) to (9), in which the calculation unit further calculates the combination of trade logistics vendors that results in the most inexpensive based on an exchange rate at a time of transportation.

(11) The trade logistics delivery arrangement system according to any one of (1) to (10), in which the predetermined condition is satisfied when the inventory quantity of the item falls below a threshold, in which case, the item to be delivered is arranged to ensure at least a predetermined inventory quantity.

(12) The trade logistics delivery arrangement system according to any one of (1) to (11), in which the ledger is a distributed ledger.

(13) A trade logistics delivery arrangement method that arranges delivery of an item in trade logistics to satisfy a condition by a combination of land transportation, sea transportation, and air transportation, including the steps of:
acquiring item information on an item stored by a customer;
recording the acquired item information into a ledger;
referring to the item information recorded in the ledger and calculating a combination of trade logistics vendors that satisfies a condition by a combination of land transportation, sea transportation, and air transportation for trade logistics of the item when the inventory quantity of the item satisfies a predetermined condition; and
arranging delivery of the item to a customer with the calculated combination of trade logistics vendors that satisfies a condition.

(14) A computer-readable program causing a trade logistics delivery arrangement system that arranges delivery of an item in trade logistics to satisfy a condition by a combination of land transportation, sea transportation, and air transportation to execute the steps of:
acquiring item information on an item stored by a customer;
recording the acquired item information into a ledger;
referring to the item information recorded in the ledger and calculating a combination of trade logistics vendors that satisfies a condition by a combination of land transportation, sea transportation, and air transportation for trade logistics of the item when the inventory quantity of the item satisfies a predetermined condition; and
arranging delivery of the item to a customer with the calculated combination of trade logistics vendors that satisfies a condition.

The computer (including CPU, an information processor, and various terminals) reads and executes a predetermined program to achieve the above-mentioned means and functions. For example, the program may be provided by a computer (SaaS: Software as a Service) through a network or a cloud service. The program may be provided in a form recorded in a computer-readable recording medium, for example. In this case, the computer reads a program from the recording medium, and forwards it to an internal or external storage, records it in the storage, and executes it. The program may be previously recorded in a storage (recording medium) and provided from the storage to the computer through a communication line.

The embodiments of the present disclosure are described above, but the present disclosure is not limited thereto. Moreover, the effects described in the embodiments of the present disclosure are only the most suitable ones produced from the present disclosure. The effects of the present disclosure are not limited to those described in the embodiments of the present disclosure.

1. A trade logistics delivery arrangement system that arranges delivery of an item in trade logistics to satisfy a condition by a combination of land transportation, sea transportation, and air transportation, comprising:
an acquisition unit that acquires item information on an item stored by a customer;
a record unit that records the acquired item information into a ledger;
a calculation unit that refers to the item information recorded in the ledger and calculates a combination of trade logistics vendors that satisfies a condition by a combination of land transportation, sea transportation, and air transportation for trade logistics of the item when the inventory quantity of the item satisfies a predetermined condition; and
an arrangement unit that arranges delivery of the item to a customer with the calculated combination of trade logistics vendors that satisfies a condition.

2. The trade logistics delivery arrangement system according to claim 1, wherein the condition is that the combination of the delivery charges of the land transportation, the sea transportation, and the air transportation is the most inexpensive.

3. The trade logistics delivery arrangement system according to claim 1, wherein the condition is that the combination of the environmental loads of the land transportation, the sea transportation, and the air transportation is the lowest.

4. The trade logistics delivery arrangement system according to claim 1, wherein the condition is that the combination of the delivery dates of the land transportation, the sea transportation, and the air transportation is the earliest.

5. The trade logistics delivery arrangement system according to claim 1, wherein the condition is that the combination of the remaining load capacities of the land transportation, the sea transportation, and the air transportation is the largest.

6. The trade logistics delivery arrangement system according to claim 1, wherein the condition includes that the combination of delivery dates of the land transportation, the sea transportation, and the air transportation satisfies a specified period.

7. The trade logistics delivery arrangement system according to claim 1, wherein the condition includes that the remaining load capacities of the land transportation, the sea transportation, and the air transportation is within their respective predetermined ranges.

8. The trade logistics delivery arrangement system according to claim 2, wherein the calculation unit further calculates the combination of trade logistics vendors that results in the most inexpensive combination of the price of the item and the delivery charge of land transportation, sea transportation, and air transportation for trade logistics of the item.

9. The trade logistics delivery arrangement system according to claim 1, wherein the arrangement unit generates information of a letter of credit, a bill of lading, a certificate of insurance, or a bill of exchange for delivery of the item.

10. The trade logistics delivery arrangement system according to claim 2, wherein the calculation unit further calculates the most inexpensive combination of trade logistics vendors based on an exchange rate at a time of transportation.

11. The trade logistics delivery arrangement system according to claim 1, wherein the predetermined condition is satisfied when the inventory quantity of the item falls below a threshold, in which case, the item to be delivered is arranged to ensure at least a predetermined inventory quantity.

12. The trade logistics delivery arrangement system according to claim 1, wherein the ledger is a distributed ledger.

13. A trade logistics delivery arrangement method that arranges delivery of an item in trade logistics to satisfy a condition by a combination of land transportation, sea transportation, and air transportation, comprising the steps of:
acquiring item information on an item stored by a customer;
recording the acquired item information into a ledger;
referring to the item information recorded in the ledger and calculating a combination of trade logistics vendors that satisfies a condition by a combination of land transportation, sea transportation, and air transportation for trade logistics of the item when the inventory quantity of the item satisfies a predetermined condition; and
arranging delivery of the item to a customer with the calculated combination of trade logistics vendors that satisfies a condition.

14. A computer-readable program causing a trade logistics delivery arrangement system that arranges delivery of an item in trade logistics to satisfy a condition by a combination of land transportation, sea transportation, and air transportation to execute the steps of:
acquiring item information on an item stored by a customer;
recording the acquired item information into a ledger;
referring to the item information recorded in the ledger and calculating a combination of trade logistics vendors that satisfies a condition by a combination of land transportation, sea transportation, and air transportation for trade logistics of the item when the inventory quantity of the item satisfies a predetermined condition; and
arranging delivery of the item to a customer with the calculated combination of trade logistics vendors that satisfies a condition.

15. The trade logistics delivery arrangement system according to claim 2, wherein the condition includes that the combination of delivery dates of the land transportation, the sea transportation, and the air transportation satisfies a specified period.

16. The trade logistics delivery arrangement system according to claim 3, wherein the condition includes that the combination of delivery dates of the land transportation, the sea transportation, and the air transportation satisfies a specified period.

17. The trade logistics delivery arrangement system according to claim 4, wherein the condition includes that the combination of delivery dates of the land transportation, the sea transportation, and the air transportation satisfies a specified period.

18. The trade logistics delivery arrangement system according to claim 5, wherein the condition includes that the combination of delivery dates of the land transportation, the sea transportation, and the air transportation satisfies a specified period.

19. The trade logistics delivery arrangement system according to claim 2, wherein the condition includes that the remaining load capacities of the land transportation, the sea transportation, and the air transportation is within their respective predetermined ranges.

20. The trade logistics delivery arrangement system according to claim 3, wherein the condition includes that the remaining load capacities of the land transportation, the sea transportation, and the air transportation is within their respective predetermined ranges.
